(19) United States
(12) Patent Application Publication
(10) Pub. No.: US 2024/0387909 A1
(43) Pub. Date: Nov. 21, 2024

(54) SOLID-STATE BATTERY PACKAGE

(71) Applicant: Murata Manufacturing Co., Ltd., Nagaokakyo-shi (JP)

(72) Inventors: Takayuki NAGANO, Nagaokakyo-shi (JP); Yoshihito NIWA, Nagaokakyo-shi (JP)

(21) Appl. No.: 18/785,553

(22) Filed: Jul. 26, 2024

Related U.S. Application Data
(63) Continuation of application No. PCT/JP2023/011964, filed on Mar. 24, 2023.

(30) Foreign Application Priority Data
Mar. 25, 2022 (JP) 2022-050492

(51) Int. Cl. H01M 50/124; H01M 50/119; H01M 50/133

(52) U.S. Cl. CPC H01M 50/124; H01M 50/119; H01M 50/133

(57) ABSTRACT

A solid-state battery package that includes: a substrate; a solid-state battery on the substrate; and a covering portion including at least: a covering insulating layer covering the solid-state battery; and a covering inorganic layer outside the covering insulating layer, wherein the covering insulating layer has a smoothed surface.

### CROSS REFERENCE TO RELATED APPLICATIONS

The present application is a continuation of International application No. PCT/JP2023/011964, filed Mar. 24, 2023, which claims priority to Japanese Patent Application No. 2022-050492, filed Mar. 25, 2022, the entire contents of each of which are incorporated herein by reference.

### TECHNICAL FIELD

The present disclosure relates to a solid-state battery package. More specifically, the present disclosure relates to a solid-state battery packaged so as to be adapted for mounting on a board.

### BACKGROUND ART

Conventionally, secondary batteries that can be repeatedly charged and discharged have been used for various applications. For example, secondary batteries are used as power sources of electronic devices such as smart phones and notebook computers.

In a secondary battery, a liquid electrolyte is generally used as a medium for ion transfer contributing to charging and discharging. That is, a so-called electrolytic solution is used for the secondary battery. However, in such a secondary battery, safety is generally required in terms of preventing leakage of the electrolytic solution. Since an organic solvent or the like used for the electrolytic solution is a flammable substance, safety is required also in that respect.

Therefore, a solid-state battery using a solid electrolyte instead of the electrolytic solution has been studied.
Patent Document 1: WO 2020/031424 A

### SUMMARY OF THE DISCLOSURE

The solid-state battery may be mounted on a printed wiring board or the like together with other electronic components. In this case, the solid-state battery disposed on a substrate can be covered with a covering member including a covering insulating layer in order to prevent transmission of water vapor. In addition, the covering member may be provided with a covering inorganic layer as an outermost layer in order to further prevent transmission of water vapor. However, the present inventor has found that when the covering inorganic layer is provided and the portion corresponding to the interface between the covering insulating layer and the covering inorganic layer includes irregularities, defects caused by the irregularities may be likely to occur in the covering inorganic layer, and the function of water vapor transmission prevention may be deteriorated as a whole.

The present disclosure has been made in view of such problems. That is, a main object of the present disclosure is to provide a solid-state battery package capable of further improving water vapor transmission prevention property.

To achieve the above object, an embodiment of the present disclosure provides a solid-state battery package including: a substrate; a solid-state battery on the substrate; and a covering portion including at least: a covering insulating layer covering the solid-state battery; and a covering inorganic layer outside the covering insulating layer, wherein the covering insulating layer has a smoothed surface.

The solid-state battery package according to an embodiment of the present disclosure can further improve water vapor transmission prevention property.

### BRIEF EXPLANATION OF THE DRAWINGS

FIG. 1 is a sectional view schematically illustrating the internal configuration of a solid-state battery.

FIG. 2 is a sectional view schematically illustrating the configuration of a packaged solid-state battery according to an embodiment of the present disclosure, and is a sectional view schematically illustrating a covering insulating layer having a smoothed surface (covering insulating layer not including a smoothed layer) as a partly enlarged sectional view.

FIG. 3 is a sectional view schematically illustrating the configuration of a packaged solid-state battery according to an embodiment of the present disclosure, and is a sectional view schematically illustrating a covering insulating layer having a smoothed surface derived from a smoothed layer.

FIG. 4 is a sectional view schematically illustrating the configuration of a packaged solid-state battery according to an embodiment of the present disclosure, and is a sectional view schematically illustrating a covering insulating layer having a smoothed surface derived from a smoothed layer and a covering inorganic layer provided as a plating layer, as a partly enlarged view.

FIG. 5 is a sectional view schematically illustrating the configuration of a packaged solid-state battery according to an embodiment of the present disclosure.

FIG. 6A is a step sectional view schematically illustrating a process for manufacturing a solid-state battery package according to an embodiment of the present disclosure.

FIG. 6B is a step sectional view schematically illustrating a process for manufacturing a solid-state battery package according to an embodiment of the present disclosure.

FIG. 6C is a step sectional view schematically illustrating a process for manufacturing a solid-state battery package according to an embodiment of the present disclosure.

FIG. 6D is a step sectional view schematically illustrating a process for manufacturing a solid-state battery package according to an embodiment of the present disclosure.

FIG. 6E is a step sectional view schematically illustrating a process for manufacturing a solid-state battery package according to an embodiment of the present disclosure.

FIG. 6F is a step sectional view schematically illustrating a process for manufacturing a solid-state battery package according to an embodiment of the present disclosure.

FIG. 6G is a step sectional view schematically illustrating a process for manufacturing a solid-state battery package according to an embodiment of the present disclosure.

FIG. 7 is a sectional view schematically illustrating the configuration of a packaged solid-state battery according to an embodiment of the present disclosure.

### DESCRIPTION OF THE PREFERRED EMBODIMENTS

Hereinafter, the solid-state battery package according to the present disclosure will be described in detail. While the description is made with reference to the drawings as necessary, the contents shown in the drawings are only schematically and illustratively shown for understanding the present disclosure, and the appearance, the dimensional ratio, and the like can be different from the actual ones.

The term “solid-state battery package” as used herein refers, in a broad sense, to a solid-state battery device configured to protect the solid-state battery from the external environment, and in a narrow sense, to a solid-state battery device that includes a mountable substrate and protects the solid-state battery from the external environment. Preferably, the solid-state battery package of the present disclosure is a surface-mount type solid-state battery package in which the package itself can be surface-mounted.

The term “sectional view” as used herein is based on a form viewed from a direction substantially perpendicular to the stacking direction in the stacked structure of the solid-state battery (briefly, a form in the case of being cut along a plane parallel to the layer thickness direction).

The terms “vertical direction” and “horizontal direction” directly or indirectly as used herein respectively correspond to the vertical direction and the horizontal direction in the drawings. Unless otherwise specified, the same reference signs or symbols denote the same members and sites, or the same semantic contents. In a preferred embodiment, it can be understood that a downward direction in a vertical direction (that is, a direction in which gravity acts) corresponds to a “downward direction”/a “bottom surface side”, and the opposite direction thereof corresponds to an “upward direction”/a “top surface side”.

In addition, herein, the phrase of “on” a substrate, a film, a layer, or the like includes not only a case of being in contact with the upper surface of the substrate, film, or layer, but also a case of being out of contact with the upper surface of the substrate, film, or layer. More particularly, the phrase of “on” a substrate, a film, or a layer includes a case where a new film or layer is formed above the substrate, film, or layer, and/or a case where another film or layer is interposed over the substrate, film, or layer. In addition, the term “on” does not necessarily mean the upper side in the vertical direction. The term “on” merely indicates a relative positional relationship of a substrate, a film, a layer, or the like.

The term “solid-state battery” used in the present disclosure refers to, in a broad sense, a battery whose constituent elements are composed of solid and refers to, in a narrow sense, an all-solid-state battery whose constituent elements (particularly preferably all constituent elements) are composed of solid. In a preferred embodiment, the solid-state battery in the present disclosure is a stacked solid-state battery configured such that layers constituting a battery constituent unit are stacked on each other, and such layers are preferably composed of fired bodies. The term “solid-state battery” encompasses not only a so-called “secondary battery” that can be repeatedly charged and discharged but also a “primary battery” that can only be discharged. According to a preferred embodiment of the present disclosure, the “solid-state battery” is a secondary battery. The term “secondary battery” is not excessively restricted by its name, which can encompass, for example, a power storage device and the like. In the present disclosure, the solid-state battery included in the package can also be referred to as a “solid-state battery element”. The “secondary battery” as used herein refers to a battery that can be repeatedly charged and discharged. Therefore, the secondary battery is not excessively limited by its name, and for example, power storage devices and the like can also be included in the subject.

Hereinafter, the basic configuration of the solid-state battery according to the present disclosure will be first described. The configuration of the solid-state battery described here is merely an example for understanding the disclosure, and not considered limiting the disclosure.

### [Basic Configuration of Solid-State Battery]

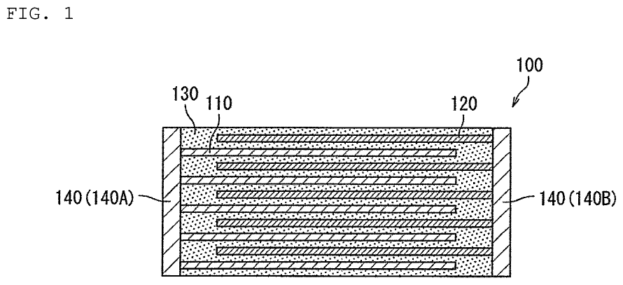

The solid-state battery includes at least electrode layers: a positive electrode and a negative electrode, and a solid electrolyte. Specifically, as illustrated in FIG. 1, a solid-state battery 100 includes a solid-state battery stacked body including a battery constituent unit composed of a positive electrode layer 110, a negative electrode layer 120, and a solid electrolyte 130 at least interposed between the electrode layers.

The solid-state battery is not particularly limited, but each layer constituting the solid-state battery may be formed by firing, and the positive electrode layer, the negative electrode layer, the solid electrolyte, and the like may form fired layers. Preferably, the positive electrode layer, the negative electrode layer, and the solid electrolyte are each fired integrally with each other, and thus, the solid-state battery stacked body preferably forms an integrally fired body.

The positive electrode layer 110 is an electrode layer containing at least a positive electrode active material. The positive electrode layer may further contain a solid electrolyte. In a preferred embodiment, the positive electrode layer is composed of a fired body including at least positive electrode active material particles and solid electrolyte particles. In contrast, the negative electrode layer is an electrode layer containing at least a negative electrode active material. The negative electrode layer may further contain a solid electrolyte. In a preferred embodiment, the negative electrode layer is composed of a sintered body containing at least negative electrode active material particles and solid electrolyte particles.

The positive electrode active material and the negative electrode active material are substances involved in the transfer of electrons in the solid-state battery. Ions move (conduct) between the positive electrode layer and the negative electrode layer through the solid electrolyte to accept and donate electrons, thereby charging and discharging are performed. Especially, each of the electrode layers, the positive electrode layer and the negative electrode layer, may be a layer capable of occluding and releasing lithium ions or sodium ions. That is, the solid-state battery may be an all-solid-state secondary battery in which lithium ions or sodium ions move between the positive electrode layer and the negative electrode layer with the solid electrolyte interposed therebetween to charge and discharge the battery.

### (Positive Electrode Active Material)

Examples of the positive electrode active material included in the positive electrode layer 110 include at least one selected from the group consisting of lithium-containing phosphate compounds that have a NASICON-type structure, lithium-containing phosphate compounds that have an olivine-type structure, lithium-containing layered oxides, lithium-containing oxides that have a spinel-type structure, and the like. Examples of the lithium-containing phosphate compounds that have a NASICON-type structure include Li₃V₂(PO₄)₃. Examples of the lithium-containing phosphate compounds that have an olivine-type structure include Li₃Fe₂(PO₄)₃, LifePO₄, and/or LiMnPO₄. Examples of the lithium-containing layered oxides include LiCoO₂ and/or LiCo_{1/3}Ni_{1/3}Mn_{1/3}O₂. Examples of the lithium-containing oxides that have a spinel-type structure include LiMn₂O₄ and/or LiNi_{0.5}Mn_{1.5}O₄. The type of the lithium compounds is not particularly limited, and may be regarded as, for example, a lithium-transition metal composite oxide and/or a lithium-transition metal phosphate compound. The lithium-transition metal composite oxide is a generic term for oxides containing lithium and one or two or more transition metal elements as constituent elements, and the lithium transition metal phosphate compound is a generic term for phosphate compounds containing lithium and one or two or more transition metal elements as constituent elements. The type of the transition metal element is not particularly limited, and examples thereof include cobalt (Co), nickel (Ni), manganese (Mn), and iron (Fe).

In addition, examples of positive electrode active materials capable of occluding and releasing sodium ions include at least one selected from the group consisting of sodium-containing phosphate compounds that have a NASICON-type structure, sodium-containing phosphate compounds that have an olivine-type structure, sodium-containing layered oxides, sodium-containing oxides that have a spinel-type structure, and the like. For example, the sodium-containing phosphate compound includes Na₃V₂(PO₄)₃, NaCoFe₂(PO₄)₃, Na₂Ni₂Fe(PO₄)₃, Na₃Fe₂(PO₄)₃, Na₄FeP₂O₇, and/or Na₄Fe₃(PO₄)₂(P₂O₇). The sodium-containing layered oxide includes NaFeO₂.

In addition, the positive electrode active material may be, for example, an oxide, a disulfide, a chalcogenide, a conductive polymer, and/or the like. The oxide may be, for example, a titanium oxide, a vanadium oxide, a manganese dioxide, and/or the like. The disulfide is, for example, a titanium disulfide, a molybdenum sulfide, and/or the like. The chalcogenide may be, for example, a niobium selenide or the like. The conductive polymer may be, for example, a disulfide, a polypyrrole, a polyaniline, a polythiophene, a poly-para-styrene, a polyacetylene, a polyacene, and/or the like.

### (Negative Electrode Active Material)

Examples of the negative electrode active material included in the negative electrode layer 120 include at least one selected from the group consisting of oxides containing at least one element selected from the group consisting of titanium (Ti), silicon (Si), tin (Sn), chromium (Cr), iron (Fe), niobium (Nb), and molybdenum (Mo), carbon materials such as graphite, graphite-lithium compounds, lithium alloys, lithium-containing phosphate compounds that have a NASICON-type structure, lithium-containing phosphate compounds that have an olivine-type structure, and lithium-containing oxides that have a spinel-type structure. Examples of the lithium alloys include Li—Al. Examples of the lithium-containing phosphate compounds that have a NASICON-type structure include Li₃V₂(PO₄)₃ and/or LiTi₂(PO₄)₃. Examples of the lithium-containing phosphate compounds that have an olivine-type structure include Li₃Fe₂(PO₄)₃ and/or LiCuPO₄. Examples of the lithium-containing oxides that have a spinel-type structure include Li₄Ti₅O₁₂.

In addition, examples of negative electrode active materials capable of occluding and releasing sodium ions include at least one selected from the group consisting of sodium-containing phosphate compounds that have a NASICON-type structure, sodium-containing phosphate compounds that have an olivine-type structure, and sodium-containing oxides that have a spinel-type structure.

Further, in the solid-state battery, the positive electrode layer and the negative electrode layer may be made of the same material, or may be made of materials different from each other.

The positive electrode layer and/or the negative electrode layer may include a conductive material. Examples of the conductive material included in the positive electrode layer and the negative electrode layer include at least one selected from the group consisting of metal materials such as silver, palladium, gold, platinum, aluminum, copper, and nickel, and carbon.

Further, the positive electrode layer and/or the negative electrode layer may contain a sintering aid. Examples of the sintering aid include at least one selected from the group consisting of lithium oxide, sodium oxide, potassium oxide, boron oxide, silicon oxide, bismuth oxide, and phosphorus oxide.

The thicknesses of the positive electrode layer and negative electrode layer are not particularly limited, but may be, independently of each other, for example, 2 μm to 50 μm, particularly 5 μm to 30 μm.

### (Positive Electrode Current Collecting Layer/Negative Electrode Current Collecting Layer)

Although not an essential element for the electrode layer, the positive electrode layer and the negative electrode layer may respectively include a positive electrode current collecting layer and a negative electrode current collecting layer. The positive electrode current collecting layer and the negative electrode current collecting layer may each have the form of a foil. The positive electrode current collecting layer and the negative electrode current collecting layer may each have, however, the form of a fired body, if more importance is placed on viewpoints such as improving the electron conductivity, reducing the manufacturing cost of the solid-state battery, and/or reducing the internal resistance of the solid-state battery by integral firing. As the positive electrode current collector constituting the positive electrode current collecting layer and the negative electrode current collector constituting the negative electrode current collecting layer, it is preferable to use a material with a high conductivity, and for example, silver, palladium, gold, platinum, aluminum, copper, and/or nickel may be used. The positive electrode current collector and the negative electrode current collector may each have an electrical connection part for being electrically connected to the outside, and may be configured to be electrically connectable to an end-face electrode. When the positive electrode current collecting layer and the negative electrode current collecting layer have the form of a fired body, the layers may be composed of a fired body including a conductive material and a sintering aid. The conductive material included in the positive electrode current collecting layer and the negative electrode current collecting layer may be selected from, for example, the same materials as the conductive materials that can be included in the positive electrode layer and the negative electrode layer. The sintering aid included in the positive electrode current collecting layer and the negative electrode current collecting layer may be selected from, for example, the same materials as the sintering aids that can be included in the positive electrode layer/the negative electrode layer. As described above, in the solid-state battery, the positive electrode current collecting layer and the negative electrode current collecting layer are not essential, and a solid-state battery provided without such a positive electrode current collecting layer or a negative electrode current collecting layer is also conceivable. More particularly, the solid-state battery included in the package of the present disclosure may be a solid-state battery without any current collecting layer (that is, a solid-state battery in which no current collecting layer is provided).

### (Solid Electrolyte)

The solid electrolyte 130 is a material capable of conducting lithium ions or sodium ions. In particular, the solid electrolyte 130 that forms a battery constituent unit in the solid-state battery may form a layer capable of conducting lithium ions between the positive electrode layer 110 and the negative electrode layer 120 (see FIG. 1). The solid electrolyte has only to be provided at least between the positive electrode layer and the negative electrode layer. More particularly, the solid electrolyte may be present around the positive electrode layer and/or the negative electrode layer so as to protrude from between the positive electrode layer and the negative electrode layer. The specific solid electrolyte is not particularly limited. For example, any one or two or more of a crystalline solid electrolyte, a glass-based solid electrolyte, and a glass ceramic-based solid electrolyte may be contained as the solid electrolyte.

Examples of the crystalline solid electrolyte include oxide-based crystal materials and/or sulfide-based crystal materials. Examples of the oxide-based crystal materials include lithium-containing phosphate compounds that have a NASICON structure, oxides that have a perovskite structure, oxides that have a garnet-type or garnet-type similar structure, and oxide glass ceramic-based lithium ion conductors. Examples of the lithium-containing phosphate compounds that have a NASICON structure include LiₓM_{y}(PO₄)₃ (1≤x≤2, 1≤y≤2, M is at least one selected from the group consisting of titanium (Ti), germanium (Ge), aluminum (Al), gallium (Ga), and zirconium (Zr)). As an example of the lithium-containing phosphate compound having a NASICON structure, Li_{1.2}Al_{0.2}Ti_{1.8}(PO₄)₃ and the like can be mentioned, for example. Examples of the oxides that have a perovskite structure include La_{0.55}Li_{0.35}TiO₃. Examples of the oxides that have a garnet-type or garnet-type similar structure include Li₇La₃Zr₂O₁₂. In addition, examples of the sulfide-based crystal materials include thio-LISICON, for example, Li_{3.25}Ge_{0.25}P_{0.75}S₄ and/or Li₁₀GeP₂S₁₂. The crystalline solid electrolyte may contain a polymer material (for example, a polyethylene oxide (PEO)).

Examples of the glass-based solid electrolyte include oxide-based glass materials and/or sulfide-based glass materials. Examples of the oxide-based glass materials include 50Li₄SiO₄-50Li₃BO₃. In addition, examples of the sulfide-based glass materials include 30Li₂S-26B₂S₃-44LiI, 63Li₂S-36SiS₂-1Li₃PO₄, 57Li₂S-38SiS₂-5Li₄SiO₄, 70Li₂S-30P₂S₅, and/or 50Li₂S-50GeS₂.

Examples of the glass ceramic-based solid electrolyte include oxide-based glass ceramic materials and/or sulfide-based glass ceramic materials. As the oxide-based glass ceramic materials, for example, a phosphate compound (LATP) containing lithium, aluminum, and titanium as constituent elements, and a phosphate compound (LAGP) containing lithium, aluminum, and germanium as constituent elements can be used. LATP is, for example, Li_{1.07}Al_{0.69}Ti_{1.46}(PO₄)₃. LAGP is, for example, Li_{1.5}Al_{0.5}Ge_{1.5}(PO₄). In addition, examples of the sulfide-based glass ceramic material include Li₇P₃S₁₁ and/or Li_{3.25}P_{0.95}S₄.

Examples of the solid electrolyte capable of conducting sodium ions include a sodium-containing phosphate compound having a NASICON structure, an oxide having a perovskite structure, and an oxide having a garnet-type structure or a garnet-type similar structure. Examples of the sodium-containing phosphate compound having a NASICON structure include NaₓM_{y}(PO₄)₃ (1≤x≤2, 1≤y≤2, and M is at least one selected from the group consisting of Ti, Ge, Al, Ga, and Zr).

The solid electrolyte may include a sintering aid. The sintering aid included in the solid electrolyte may be selected from, for example, the same materials as the sintering aids that can be included in the positive electrode layer/the negative electrode layer.

The thickness of the solid electrolyte is not particularly limited. The thickness of the solid electrolyte layer located between the positive electrode layer and the negative electrode layer may be, for example, 1 μm to 15 μm, particularly 1 μm to 5 μm.

### (End-Face Electrode)

The solid-state battery typically includes an end-face electrode 140. In particular, an end-face electrode is provided on a side surface of the solid-state battery. More specifically, a positive-electrode-side end-face electrode 140A connected to the positive electrode layer 110 and a negative-electrode-side end-face electrode 140B connected to the negative electrode layer 120 are provided (see FIG. 1). Such end-face electrodes preferably contain a material that is high in conductivity. The specific material for the end-face electrode is not particularly limited, but examples thereof include at least one selected from the group consisting of silver, gold, platinum, aluminum, copper, tin, and nickel.

### [Basic Configuration of Solid-State Battery Package]

According to the present disclosure, the solid-state battery is packaged. More particularly, the solid-state battery package includes a mountable substrate, and has a configuration in which the solid-state battery is protected from the external environment.

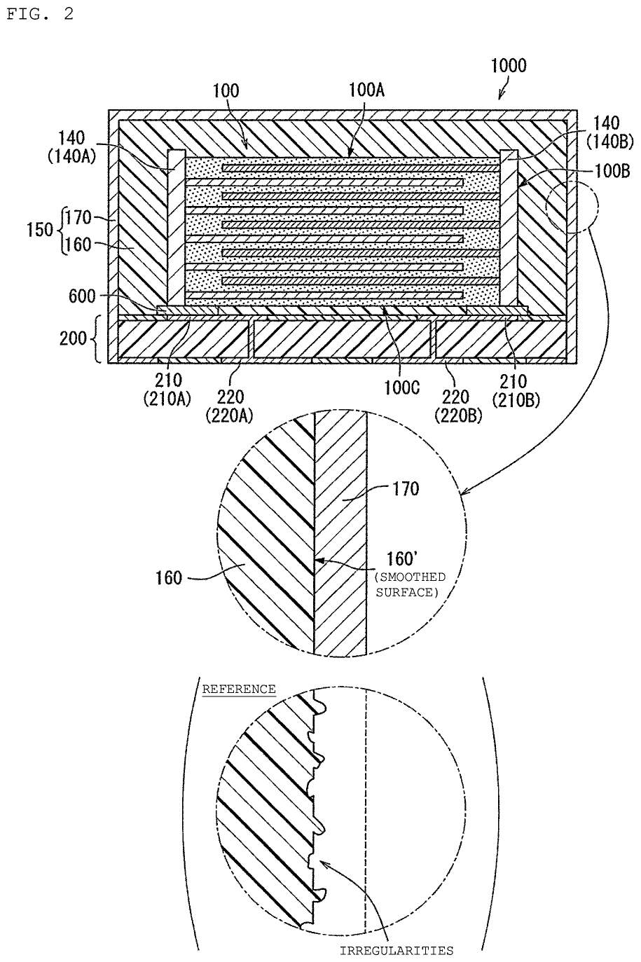

FIG. 2 is a sectional view schematically illustrating the configuration of a packaged solid-state battery according to an embodiment of the present disclosure. As illustrated in FIG. 2, a solid-state battery package 1000 according to an embodiment of the present disclosure includes a substrate 200 so that a solid-state battery 100 is supported. Specifically, the solid-state battery package 1000 includes the mountable substrate 200 and the solid-state battery 100 provided on the substrate 200 and protected from the external environment. Such a solid-state battery package 1000 is provided with a covering portion 150 configured by at least a covering insulating layer 160 provided to cover the solid-state battery 100 on the substrate 200 and a covering inorganic layer 170 provided outside the covering insulating layer (preferably, a covering inorganic layer 170 provided directly on or in contact with the outside of the covering insulating layer).

As illustrated in FIG. 2, the substrate 200 may have, for example, a main surface larger than the solid-state battery. The substrate 200 may be a resin substrate or a ceramic substrate. In short, the substrate 200 may fall in the category such as a printed wiring board, a flexible substrate, an LTCC substrate, and/or an HTCC substrate. When the substrate 200 is a resin substrate, the substrate 200 may be a substrate composed to include a resin as the base material, for example, a substrate that has a laminated structure including therein a resin layer. The resin material of such a resin layer may be any thermoplastic resin and/or any thermosetting resin. In addition, the resin layer may be formed by impregnating a glass fiber cloth with a resin material such as an epoxy resin, for example.

The substrate preferably serves as a member for an external terminal of the packaged solid-state battery. That is, the substrate may be a terminal substrate for the external terminal of the solid-state battery. The solid-state battery package provided with such a substrate allows the solid-state battery to be mounted on another secondary substrate such as a printed wiring board, with the substrate interposed therebetween. For example, the solid-state battery can be surface-mounted with the substrate interposed therebetween, through solder reflow and the like. For the reasons described above, the solid-state battery package according to the present disclosure is preferably a surface-mount-device (SMD) type battery package.

Such a substrate can be provided to support the solid-state battery, and can thus also be referred to as a support substrate. In addition, the substrate, as a terminal substrate, may have a wiring, an electrode layer, or the like, and in particular, may include an electrode layer that electrically connects the upper and lower surfaces or the upper and lower surface layers in the substrate. That is, in a preferred embodiment, the substrate includes wiring or an electrode layer that electrically wires the upper and lower surfaces of the substrate, and is a terminal substrate for an external terminal of the packaged solid-state battery. Such an embodiment enables the wiring of the substrate to be used for extension from the solid-state battery to the external terminal, and thus requires no extension to the outside of the package while packing with the covering material, thereby increasing the design freedom of the external terminal.

The substrate 200 according to a preferred embodiment includes electrode layers (upper main surface electrode layer 210 and lower main surface electrode layer 220) that electrically connects the upper and lower main surfaces of the substrate, and serves as a member for an external terminal of the packaged solid-state battery (see FIG. 2). In the solid-state battery package including such a substrate, the electrode layers of the substrate and terminal parts of the solid-state battery are connected to each other. Preferably, the electrode layers of the substrate and the end-face electrodes of the solid-state battery are electrically connected to each other. For example, the positive-electrode-side end-face electrode 140A of the solid-state battery is electrically connected to the positive-electrode-side electrode layers (210A, 220A) of the substrate. In contrast, the negative-electrode-side end-face electrode 140B of the solid-state battery is electrically connected to the negative-electrode-side electrode layers (210B, 220B) of the substrate. Thus, the positive-electrode-side and negative-electrode-side electrode layers (in particular, the electrode layers located on the lower side/bottom side of the packaged product, or lands connected thereto) of the substrate are provided respectively as a positive electrode terminal and a negative electrode terminal for the battery package.

For enabling electrical connection between the solid-state battery 100 and the substrate electrode layers 210 of the substrate 200, the end-face electrodes 140 of the solid-state battery 100 and the substrate electrode layers 210 of the substrate 200 can be connected with a bonding member 600 interposed therebetween. The bonding member 600 may be provided on the substrate 200. The bonding member 600 is responsible for at least electrical connection between the end-face electrodes 140 of the solid-state battery 100 and the substrate 200, and may include, for example, a conductive adhesive. As an example, the bonding member 600 may be made of an epoxy-based conductive adhesive containing a metal filler such as Ag.

Furthermore, according to an embodiment of the present disclosure, the solid-state battery package 1000 itself can be configured to prevent water vapor transmission as a whole. For example, the solid-state battery package 1000 according to an embodiment of the present disclosure is covered with a covering material 150 such that the whole of the solid-state battery 100 provided on the substrate 200 is surrounded. Specifically, the solid-state battery 100 on the substrate 200 can be packaged such that the main surface (at least the upper surface 100A corresponding to the top surface, preferably both the upper surface 100A and the lower surface 100C) and the side surface 100B are surrounded with the covering material 150. According to such a configuration, the surface forming the solid-state battery 100 (preferably, all the surfaces forming the solid-state battery 100) is not exposed to the outside, and preferably, such a surface is not directly exposed to the outside, so that water vapor transmission can be more suitably prevented.

The term “water vapor” as used herein is not particularly limited to water in a gaseous state, and preferably also encompasses water in a liquid state and the like. More particularly, the term “water vapor” is used to broadly encompass water in a gaseous state, water in a liquid state, and the like, regardless of the physical state. Accordingly, the term “water vapor” can also be referred to as moisture or the like, and in particular, water in a liquid state can also encompass dew condensation water obtained by condensation of water in a gaseous state. The penetration of water vapor into the solid-state battery causes battery characteristics to be degraded, and thus, the form of the solid-state battery packaged as described above contributes to prolonging the life of the battery characteristics of the solid-state battery.

For example, as illustrated in FIG. 2, the covering member 150 may include at least the covering insulating layer 160 and the covering inorganic layer 170. The solid-state battery 100 may have a form of being covered with the covering insulating layer 160 and the covering inorganic layer 170 as the covering material 150. The covering inorganic layer 170 is provided to cover the covering insulating layer 160. As shown in FIG. 2, the covering inorganic layer 170 is positioned on the covering insulating layer 160, and thus has a form of largely enclosing the solid-state battery 100 on the substrate 200 as a whole together with the covering insulating layer 160. The covering inorganic layer 170 may also cover the side surface of the substrate 200.

[Feature of Solid-State Battery Package according to Present Disclosure]

The present inventor has intensively studied a solution for further improving the water vapor transmission prevention property of the solid-state battery package, and as a result, has devised the present disclosure having the following technical idea.

Specifically, the present disclosure has a technical idea that a solid-state battery package including a solid-state battery provided on a substrate includes a “covering insulating layer having a smoothed surface”. More specifically, the present disclosure has a technical idea that “the covering portion preferably has a covering insulating layer having a developed area ratio Sdr of 0.15 or less”.

As a realization of the above technical idea, the present disclosure has technical features described below. FIG. 2 schematically illustrates the smoothed surface of the solid-state battery package 1000 as a partly enlarged sectional view. As can be seen from the partly enlarged sectional view, the solid-state battery package 1000 of the present disclosure has a structure/configuration of the covering insulating layer 160 having a smoothed surface (for example, a smoothed surface 160′).

The term “having a smoothed surface” as used herein means that the covering insulating layer has reduced surface irregularities, preferably, the covering insulating layer has a smooth surface. For example, the term means a state that, in the covering insulating layer, the surface unevenness of the outer surface or the outermost layer is reduced. For example, the covering insulating layer serving as a base member or a main member (or a portion thereof) is optionally combined with other elements, and may have a form in which the covering insulating layer has a smoothed or plain/flat outer surface (preferably an outermost side surface or an outermost surface). In a preferred embodiment, as the “having a smoothed surface”, the surface of the covering portion forming the interface with the covering inorganic layer (particularly, the surface related to the covering insulating layer) has a smoothed surface. In a preferred embodiment, the layer positioned inside the covering inorganic layer, preferably the covering insulating layer positioned immediately inside the covering inorganic layer, has a smoothed surface (in particular, a smoothed outer surface) or a plain/flat surface (in particular, a plain/flat outer surface).

In addition, the term “covering insulating layer” as used herein is not limited to one including a single layer, and may be one including a plurality of layers. For example, the covering insulating layer may have a sublayer on the surface thereof, and preferably may have a sublayer provided to reduce the surface irregularities (By way of example, the sublayer may have a smoothed surface (in particular, a smoothed outer surface) or a plain/flat surface (in particular, a plain/flat outer surface)). In other words, the covering insulating layer may include a first covering insulating layer and a second covering insulating layer provided on the outer surface of the covering insulating layer (preferably, a second covering insulating layer having a thickness smaller than that of the first covering insulating layer). In the covering insulating layer, it can also be said that the second covering insulating layer (preferably the surface thereof) provided on the surface irregularities of the first covering insulating layer may form or serve as the outer surface (or the outermost side surface or the outermost surface) of the covering insulating layer.

As schematically exemplified in FIG. 2, in the solid-state battery package 1000 of the present disclosure, the interface between the covering insulating layer 160 and the covering inorganic layer 170 may be smoothed. In addition, the covering insulating layer 160 preferably has a developed area ratio Sdr of 0.15 or less. More specifically, the covering insulating layer (for example, a covering insulating layer composed of a single layer, or a covering insulating layer composed of two or more layers/sublayers) may have a surface (particularly, the outer surface) having a developed area ratio Sdr of 0.15 or less. The case where the developed area ratio Sdr is 0 means a state where the surface has no irregularities. In the present disclosure, the developed area ratio Sdr of the covering insulating layer 160 is preferably 0 to 0.15 or to 0.14 (Sometimes the developed area ratio Sdr may be more than 0 and 0.15 or less or 0.14 or less without including 0). When the developed area ratio Sdr of the covering insulating layer 160 is 0.15 or less, defects in the covering inorganic layer 170 caused by the surface irregularities of the covering insulating layer 160 can be easily suppressed, or preferably eliminated. When the defects in the covering inorganic layer 170 is suppressed or eliminated, water vapor from the external environment is more suitably prevented from entering the solid-state battery. In a preferred embodiment, the surface (particularly the outer surface) of the covering insulating layer may have a developed area ratio Sdr of 0.01 to 0.15, 0.02 to 0.15, 0.03 to 0.15, 0.03 to 0.14, 0.04 to 0.15, 0.05 to 0.15, 0.06 to 0.15, 0.07 to 0.15, 0.08 to 0.15, 0.09 to 0.15, 0.1 to 0.15, 0.11 to 0.15, or 0.11 to 0.14.

The term “developed area ratio Sdr” as used herein is an Sdr value obtained by measuring the surface roughness using a laser microscope (model number VK-X3050, which is manufactured by KEYENCE CORPORATION), and an arithmetic average value of arbitrary 20 points on the target surface may be adopted.

The covering insulating layer contributes to covering the solid-state battery and has an insulating property. The material of the covering insulating layer may be any type as long as the material exhibits an insulating property. The term “insulation” as used herein may refer to an insulation property of a general insulator, that is, an electrical resistivity of a general insulator in the fields of, for example, batteries or solid-state batteries. Although it is merely an example, the resistivity (room temperature: 20° C.) may be at least 1.0×10⁵ Ω·m or more, preferably 1.0×10⁶ Ω·m or more, and more preferably 1.0×10⁷ Ω·m or more. Preferably, the covering insulating layer is composed of a resin. For example, when the covering insulating layer is a resin layer, the resin may be either a thermosetting resin or a thermoplastic resin. Although not particularly limited, examples of the specific resin material of the covering insulating layer include an epoxy-based resin, a silicone-based resin, and/or a liquid crystal polymer. Although it is merely an example, the thickness (for example, the maximum thickness) of the covering insulating layer may be 30 μm to 1000 μm, and is, for example, 50 μm to 300 μm.

In a preferred embodiment, the covering insulating layer contains silicon. For example, the material of the covering insulating layer may be a resin containing silicon. Silicon may be contained separately from the resin component of the covering insulating layer (For example, silicon may be contained in the resin base material of the covering insulating layer separately from the resin base material). That is, it can also be said that the covering insulating layer may contain silicon as a non-resin component. For such silicon, the covering insulating layer may contain a silicon compound. When the covering insulating layer is a resin layer, the covering insulating resin layer may contain a silicon compound. For example, a silicon compound may be dispersed and contained in the resin base material of the covering insulating layer. Examples of the silicon compound include silicon oxide such as silicon dioxide. When such silicon (Si) and/or a silicon compound (for example, silicon oxide) is contained in the covering insulating layer, the adhesion between the covering insulating layer and the covering inorganic layer can be further enhanced by the action of Si.

The covering insulating layer 160 may contain a filler. The filler may be an inorganic filler. When the covering insulating layer 160 is made of a resin, a filler is preferably dispersed in such a resin. The filler is preferably mixed in the covering insulating layer to be combined and integrated with a base material (for example, a resin material) of the covering insulating layer. The shape of the filler is not particularly limited, and may be granular, spherical, needle, plate, fiber, and/or amorphous. The size of the filler is also not particularly limited, and may be 10 nm to 100 μm, and may be, for example, a nanofiller of 10 nm to less than 100 nm, a microfiller of 100 nm to less than 10 μm, or a macrofiller of 10 μm to 100 μm. The content of the filler in the covering insulating layer based on the whole of the covering insulating layer 160 may be 0 wt % or more (for example, not including 0 wt %) and 95 wt % or less, for example, 0 wt % or more (for example, not including 0 wt %) and 50 wt % or less, 0 wt % or more (for example, not including 0 wt %) and 40 wt % or less, 0 wt % or more (for example, not including 0 wt %) and 35 wt % or less, or 0 wt % or more (for example, not including 0 wt %) and 30 wt % or less, and further, 5 wt % to 50 wt %, 5 wt % to 45 wt %, 5 wt % to 40 wt %, 5 wt % to 35 wt %, 10 wt % to 50 wt %, 10 wt % to 45 wt %, 10 wt % to 40 wt %, 10 wt % to 35 wt %, 15 wt % to 50 wt %, 15 wt % to 45 wt %, 15 wt % to 40 wt %, 15 wt % to 35 wt %, 20 wt % to 50 wt %, 20 wt % to 45 wt %, 20 wt % to 40 wt %, 20 wt % to 35 wt %, 25 wt % to 50 wt %, 25 wt % to 45 wt %, 25 wt % to 40 wt %, 25 wt % to 35 wt %, or the like. Regarding the wt %, the “based on the whole of the covering insulating layer” may be understood that the “based on the whole of the covering insulating layer” is “based on the whole of the first covering insulating layer” when the covering insulating layer includes a first covering insulating layer and a second covering insulating layer thereon as described above. Furthermore, the content of the filler in such a covering insulating layer may be less than 10 wt %, less than 9 wt %, less than 8 wt %, less than 7 wt %, less than 6 wt %, 5 wt % or less (for example, may be more than 0, not including 0, and less than or not more than such wt %), as described below.

The filler contained in the covering insulating layer preferably contributes to water vapor transmission prevention. That is, the filler may be contained in the covering insulating layer as a water vapor transmission-preventing filler. Such a water vapor transmission-preventing filler may be, for example, an inorganic filler, and may be, for example, a filler containing or consisting of silicon (Si) and/or a silicon compound (for example, silicon oxide). In a preferred embodiment, the covering insulating layer 160 contains a water vapor transmission-preventing filler in the resin material. As a result, the covering insulating layer 160 can more suitably prevent water vapor in the external environment from entering the solid-state battery together with the covering inorganic layer 170.

Specific examples of the material for the filler include, but are not limited to, metal oxides such as silica, alumina, titanium oxide, and/or zirconium oxide; minerals such as mica; and/or glass.

As described above, silicon (Si) and/or a silicon compound are preferably contained in the covering insulating layer 160. From such a viewpoint, silicon (Si) contained in the covering insulating layer 160 may be an oxide of silicon (Si), that is, a silicon compound such as silicon oxide, and may be, for example, silica (silicon dioxide). Such silicon (Si) and/or a silicon compound (for example, silicon oxide) may be included as a filler (for example, may be contained in the covering insulating layer as the above-described filler). In other words, the covering insulating layer may contain a filler of silicon or silicon oxide, and such a filler containing silicon such as a silicon or silicon compound-containing filler may be dispersed and contained in the layer of the covering insulating layer 160.

In the present disclosure, the smoothness or leveling/flatness of the covering insulating layer 160 can be controlled by the content of the filler in the covering insulating layer. For example, the smoothness or leveling/flatness of the covering insulating layer 160 can be controlled by a filler containing silicon (Si) and/or a silicon compound (for example, silicon oxide) (In a preferred exemplary embodiment, the covering insulating layer can have a smoothed surface when the “smoothed layer” described later is not provided). More specifically, as the content of the filler increases, the surface roughness tends to become rough. Although not bound by a specific theory, this is presumably due to cracking or falling of the filler. On the other hand, when the filler is contained in a smaller amount, the surface roughness can be suitably suppressed. As the content of the filler is smaller, the covering insulating layer has a highly smoothed surface (That is, a highly leveled or flat covering insulating layer can be obtained). When the content of the filler in the covering insulating layer is low to some extent, the smoothness or leveling/flatness of the covering insulating layer can be exhibited while taking advantage of the water vapor transmission-preventing property of the filler, and defects in the covering inorganic layer caused by surface irregularities can be reduced or suppressed, and desired water vapor transmission properties can be obtained. From such a viewpoint, the content of the filler in the covering insulating layer may be less than 10 wt %, less than 9 wt %, less than 8 wt %, less than 7 wt %, less than 6 wt %, or 5 wt % or less (for example, may be more than 0, not including 0, and less than or not more than such wt %) based on the covering insulating layer (when the covering insulating layer does not include the first covering insulating layer and the second covering insulating layer as described in Examples and the like, based on the part of the covering insulating layer corresponding to the first covering insulating layer). When the filler contained in the covering insulating layer 160 contains silicon (Si) and/or a silicon compound (for example, silicon oxide), the adhesion between the covering insulating layer and the covering inorganic layer tends to be higher due to the action of Si and/or the anchor effect as the content of such a filler increases.

The term “having a smoothed surface” or “smoothed surface” (particularly a smoothed outer surface) or “plain/flat surface” (particularly a plain/flat outer surface) in the solid-state battery package of the present disclosure may be formed by a smoothed layer. The term “smoothed layer” as used herein may correspond to a second covering insulating layer provided to reduce surface irregularities of the covering insulating layer, and can be referred to as a smoothed sublayer, a smoothed sub-insulating layer, a smoothed sub-covering insulating layer, or the like, or can also be referred to as a smoothed surface layer, a planarized layer, or the like. Such a layer is provided on the surface of the covering insulating layer as the first covering insulating layer, and therefore can also be referred to as a surface insulating layer. For example, the smoothed layer may be provided as the outermost layer/outermost sublayer of the covering insulating layer 160. The smoothed layer may be a layer or a sublayer having the smallest thickness among the covering insulating layers.

More specifically, as shown in FIG. 3, the covering insulating layer 160 may include a smoothed layer 160B, and the covering inorganic layer 170 may be provided on the smoothed layer 160B. That is, when the covering insulating layer 160 includes a covering insulating layer 160A directly in contact with the solid-state battery 100 as the first covering insulating layer and a smoothed layer 160B provided as the second covering insulating layer on the first covering insulating layer, the smoothed layer 160B may be positioned between the first covering insulating layer 160A and the covering inorganic layer 170 (for example, a plating layer). As illustrated in the drawings, the smoothed layer 160B may be provided as the outer surface layer of the covering insulating layer 160, and the covering inorganic layer 170 may be provided on the outer surface of the smoothed layer 160B. Particularly when the surface of the first covering insulating layer (particularly, the outer surface of the first covering insulating layer) has irregularities, the smoothed layer provided as the second covering insulating layer may be provided to fill the surface irregularities of the first covering insulating layer.

As shown in FIG. 3, the smoothed layer 160B is provided so as to surround the solid-state battery 100. That is, as shown in the drawing, at least the smoothed layer 160B is provided so as to be located outside the side surface and/or the upper surface (that is, the top surface corresponding to the main surface relatively farther away from the substrate) of the solid-state battery 100 (preferably, continuously provided in a sectional view). More specifically, the smoothed layer 160B may be provided so as to form the surface of the covering insulating layer 160 provided to surround the solid-state battery 100 on the substrate 200. The smoothed layer 160B may have a developed area ratio Sdr of 0.15 or less. The case where the developed area ratio Sdr is 0 is a state where the surface has no irregularities as described above.

In a preferred embodiment, the developed area ratio Sdr of the smoothed layer 160B is 0 to 0.15, or 0 to 0.14 (Sometimes the developed area ratio Sdr may be more than 0 and 0.15 or less without including 0). In particular, the outer surface of the smoothed layer 160B (that is, the surface located relatively outside the solid-state battery package) preferably has a developed area ratio Sdr of 0 to 0.15 (Sometimes the developed area ratio Sdr exceeds 0, does not include 0, and is 0.15 or less, 0.14 or less, or less than 0.1). When the developed area ratio Sdr of the smoothed layer 160B is 0.15 or less, defects in the covering inorganic layer 170 due to surface irregularities of the covering insulating layer 160 including the smoothed layer 160B are easily suppressed, or can be preferably eliminated. When the defects in the covering inorganic layer 170 is suppressed or eliminated, water vapor from the external environment can be more suitably prevented from entering the solid-state battery. In such an embodiment, the covering insulating layer includes the smoothed layer to form the covering insulating layer. That is, it can be understood that the covering insulating layer in the present disclosure is constituted by the first covering insulating layer and the smoothed layer as the second covering insulating layer thereon (provided on the surface or the surface irregularities thereof). In a preferred embodiment, the outer surface of the smoothed layer 160B may have a developed area ratio Sdr of 0.01 to less than 0.1, 0.01 to 0.09, 0.02 to 0.09, 0.03 to 0.09, 0.04 to 0.09, 0.04 to 0.08, or the like.

Here, it is assumed that the covering insulating layer 160, in particular, the first covering insulating layer contains a filler. As described above, the filler itself contributes to prevention of water vapor transmission, and thus is preferable in that respect. However, when the content of the filler increases, the smoothness or leveling/flatness of the first covering insulating layer can be reduced. Therefore, when the content of the filler is increased, surface irregularities are easily generated in the covering insulating layer (first covering insulating layer), and therefore defects in the covering inorganic layer 170 are easily generated. In this regard, when the smoothed layer 160B is provided on the first covering insulating layer 160A, the covering insulating layer 160 serving as a base or foundation on which the covering inorganic layer 170 is formed has more suitable smoothness or leveling/flatness, so that defects in the covering inorganic layer 170 caused by surface irregularities are reduced, and can be preferably eliminated. That is, while further utilizing the water vapor transmission prevention property of the filler, defects in the covering inorganic layer 170 caused by surface irregularities can be reduced or eliminated by the smoothness or leveling/flatness of the covering insulating layer 160, and finally, desired water vapor transmission properties can be easily obtained. In terms of further utilizing the water vapor transmission prevention property of the filler when the smoothed layer 160B is provided, the content of the filler in the covering insulating layer based on the first covering insulating layer may be 10 wt % or more, 15 wt % or more, 20 wt % or more, 25 wt % or more, 26 wt % or more, 27 wt % or more, 28 wt % or more, 29 wt % or more, or 30 wt % or more (The upper limit thereof is not particularly limited, but may be 50 wt % or less, 45 wt % or less, 40 wt % or less, 35 wt % or less, 34 wt % or less, 33 wt % or less, 32 wt % or less, 31 wt % or less, or the like).

In a preferred embodiment, in the covering insulating layer, the first covering insulating layer contains a filler, while the second covering insulating layer (that is, the smoothed layer) does not contain a filler. That is, the covering insulating layer may include a first covering insulating layer provided as a filler-containing insulating layer and a second covering insulating layer provided as an insulating layer containing no filler (that is, a smoothed layer provided as an insulating layer containing no filler). In such an embodiment, while further utilizing the water vapor transmission prevention property of the filler, defects in the covering inorganic layer caused by surface irregularities can be reduced or eliminated by the smoothness or leveling/flatness of the covering insulating layer, and finally, desired water vapor transmission properties can be easily obtained. Such a “smoothed layer provided as an insulating layer containing no filler” can also be referred to as a smoothed layer containing no filler, a smoothed layer having no dispersed filler, a smoothed layer not containing a filler or not having a dispersed filler, or the like.

The smoothed layer 160B may be made of a resin. A silicon-containing layer that contains silicon is preferable. Examples of the resin of the smoothed layer include a silicon-containing resin, a silicon-based resin, and/or a silicone resin. As described above, when the smoothed layer 160B contains Si (silicon) as the constituent element of its resin material, surface irregularities in the outermost layer of the covering insulating layer 160 are easily reduced, and defects in the covering inorganic layer 170 provided thereon are easily suppressed. In addition, in such a smoothed layer, the adhesion with the covering inorganic layer 170 is easily improved by the action of Si or the like, and the covering inorganic layer 170 more easily maintains the function as a water vapor barrier film. Therefore, the water vapor in the external environment is more suitably prevented from entering the solid-state battery 100.

The smoothed layer containing silicon may contain an alkoxysilane. That is, the silicon-containing layer (in particular, a smoothed layer as a silicon-containing resin layer preferably containing Si (silicon) as the constituent element of the layer resin material) may contain an alkoxysilane. The alkoxysilane-containing layer is easily provided as a relatively dense and/or homogeneous thin layer while contributing more suitably to having a smoothed surface. That is, in the smoothed layer containing an alkoxysilane, the effect of reducing surface irregularities in the covering insulating layer is more likely to become apparent, and defects in the covering inorganic layer provided thereon are more likely to be suppressed more effectively. A raw material containing an alkoxysilane may be applied to the covering insulating layer 160, whereby the smoothed layer 160B may be provided on the surface of the covering insulating layer 160 to reduce surface irregularities in the covering insulating layer 160. The kind of the alkoxysilane is not particularly limited, and any alkoxysilane can be used as long as it contributes to the covering insulating layer having a smoothed surface. Since the smoothed layer containing silicon such as a layer containing an alkoxysilane contains the silicon, the adhesion of the covering inorganic layer provided as a plating layer on the covering insulating layer can be easily improved or enhanced, and the covering inorganic layer easily and suitably maintains (for example, easily maintains for a long period) the function as a water vapor barrier.

The method for forming the smoothed layer 160B is not particularly limited. For example, the smoothed layer 160B may be formed by impregnation into a resin as a raw material or a solution containing a resin, or may be formed by sputtering. Although it is merely an example, the smoothed layer 160B can be formed by applying an alkoxysilane solution to the surface of the first covering insulating layer 160A.

The smoothed layer 160B may be a single layer (for example, may be a single layer in that the layer is formed of the same material). The thickness of the smoothed layer 160B is not particularly limited as long as the irregularities of the covering insulating layer 160 becomes a smoothed surface. The thickness (for example, the minimum thickness) of the smoothed layer 160B may be smaller than the thickness of the first covering insulating layer 160A (that is, the inner covering insulating layer in direct contact with the solid-state battery) and/or may be smaller than the thickness of the covering inorganic layer 170. Specifically, the thickness may be nano-order or micro-order. Although it is merely an example, the thickness of the smoothed layer may be 0.6 μm or more, 0.8 μm or more, 0.9 μm or more, 1 μm or more, 1.1 μm or more, 1.2 μm or more, or the like. The upper limit of the thickness of the smoothed layer is not particularly limited, and may be, for example, 20 μm, 10 μm, 5 μm, 4 μm, 3 μm, or 2 μm. Although such a thin layer, the smoothed layer 160B may be a relatively dense and/or homogeneous layer. The smoothness of the covering insulating layer 160 can be controlled by, for example, the thickness of the smoothed layer. When the thickness of the smoothed layer is thin, the effect of smoothing may be relatively reduced. On the other hand, when the thickness of the smoothed layer is larger, the effect of smoothing is enhanced, and the water vapor barrier property is further improved. The thickness of the smoothed layer can also be controlled by various elements related to the raw material solution for forming the smoothed layer, for example, the concentration of the alkoxysilane solution and/or the number of times of coating. Herein, regarding the term “thickness of the smoothed layer”, the minimum thickness in the smoothed layer may be regarded as the thickness of the smoothed layer.

The covering insulating layer having a smoothed surface (for example, smoothed layer 160B) can easily suppress or eliminate a phenomenon that, when the covering inorganic layer 170 is formed by plating, the plating solution undesirably remains in a recess on the surface of the outermost layer of the covering insulating layer 160. That is, due to the smoothed layer 160B, such an undesirable phenomenon is easily suppressed, and the covering inorganic layer 170 is more suitably provided as a water vapor barrier film. Therefore, in the solid-state battery package, water vapor in the external environment can be more suitably prevented from entering the solid-state battery 100.

The present disclosure provides water vapor barrier properties to the solid-state battery package due to “having a smoothed surface”. The term “barrier” as used herein broadly means having such a characteristic of blocking water-vapor transmission (water vapor transmission to the solid-state battery) that water vapor in the external environment does not permeate the covering portion (particularly the covering inorganic layer 170) to cause degradation of characteristics that is inconvenient to the solid-state battery 100, and narrowly means having a water-vapor transmission rate of less than 1.0 g/(m²·day), preferably less than 0.5 g/(m²·day), and more preferably less than 0.2 g/(m²·day) by the method recited in EXAMPLES described later (a method based on weight change amount when the solid-state battery is left for 24 hours under an environment of 85° C. and 85% RH).

In a preferred embodiment, the covering insulating layer 160 and the covering inorganic layer 170 are integrated with each other, and preferably, they are integrated to be in direct contact with each other. For example, the covering insulating layer 160 and the covering inorganic layer 170 are integrated with each other via the smoothed layer 160B of the covering insulating layer (Alternatively, the covering insulating layer 160 and the covering inorganic layer 170 are integrated with each other without such a smoothed layer interposed therebetween). Hence, the covering inorganic layer 170 forms a water vapor barrier for the solid-state battery 100 together with the covering insulating layer 160. In other words, water vapor in the external environment is more suitably prevented from entering the solid-state battery 100 by the combination of the integrated covering insulating layer 160 and covering inorganic layer 170.

The covering inorganic layer 170 may correspond to an inorganic layer having a thin film form, and in this case, for example, may be a metal film. The thickness of such a covering inorganic layer may be 0.1 μm to 100 μm, and may be, for example, 1 μm to 50 μm. In a preferred embodiment, the covering inorganic layer is a plating layer. That is, the covering inorganic layer is made of metal, and in particular, may contain a plating metal. The covering inorganic layer may contain at least one metal selected from a group consisting of Cu, Sn, Zn, Bi, Au, Ag, Ni, Cr, Pd, Pt, SUS, and Zn. The covering inorganic layer containing such a material contributes to more suitable water vapor transmission prevention property of the solid-state battery package. The term “SUS (stainless steel)” as used herein refers to, for example, stainless steel defined in “JIS G0203 Glossary of terms used in iron and steel”, and may be chromium or alloy steel containing chromium and nickel.

In a preferred embodiment, the plating layer includes a dry-plating layer disposed on the covering insulating layer and a wet-plating layer thereon. That is, the plating layer may be constituted by a plating inner layer formed on the covering insulating layer by dry-plating treatment and a plating outer layer formed on the plating lower layer by wet-plating treatment. In other words, the solid-state battery package of the present disclosure may include a dry-plating layer disposed on the smoothed covering insulating layer and a wet-plating layer disposed on the dry-plating layer. The wet-plating layer may be provided to cover the dry-plating layer.

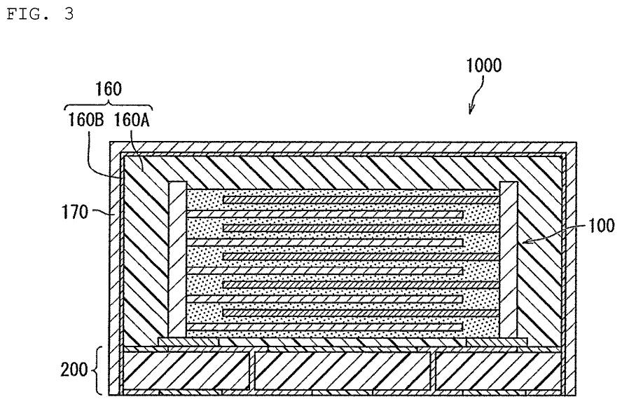

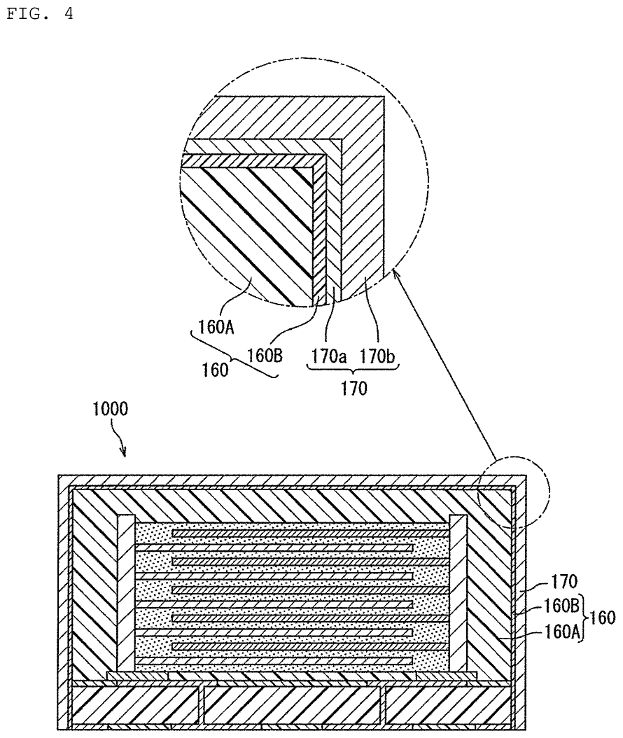

The smoothed layer 160B may be provided as the outer surface layer (outer surface sublayer) of the covering insulating layer 160, and a plating layer may be provided as the covering inorganic layer on the outer surface of the smoothed layer 160B. As shown in FIG. 4, for example, the smoothed layer 160B may be provided as the outer surface layer of the covering insulating layer 160, and a dry-plating layer 170a on the outer surface of the smoothed layer 160B and a wet-plating layer 170b disposed on the dry-plating layer 170a may be provided. Each of the dry-plating layer 170a and the wet-plating layer 170b may have a multilayer structure including two or more layers. For example, the wet-plating layer 170b may be composed of at least the first wet-plating layer and the second wet-plating layer. In this case, the first wet-plating layer may contain at least one metal selected from a group consisting of Cu, Sn, Zn, Bi, Au, and Ag. On the other hand, the second wet-plating layer may contain at least one metal selected from a group consisting of Ni, Cr, Pd, Pt, Zn, and Cu. The covering inorganic layer containing such a material contributes to more suitable water vapor transmission prevention property of the solid-state battery package.

As for the plating layer, the dry-plating layer 170a and the wet-plating layer 170b may be laminated in this order on the covering insulating layer 160. The dry-plating layer 170a may be formed by sputtering. Since the covering insulating layer 160 is a layer having a smoothed surface, the dry-plating layer 170a can more suitably adhere to the covering insulating layer 160. Therefore, the dry-plating layer 170a can more suitably contribute to water vapor transmission prevention for the solid-state battery 100 together with the covering insulating layer 160.

Furthermore, in sputtering, the sputtered film easily bites into the covering insulating layer 160 and can more suitably adhere to the covering insulating layer 160. In other words, the sputtered film provided to cover at least the main surface and side surface of the solid-state battery together with the covering insulating layer 160 may be more suitably used as a barrier to prevent water vapor in the external environment from entering the solid-state battery 100. Further, the dry-plating layer 170a provided inside the wet-plating layer 170b can more easily and suitably prevent the plating solution used for forming the wet-plating layer 170b from entering the solid-state battery. Therefore, the dry-plating layer 170a provided on the covering insulating layer 160 having a smoothed surface easily achieve a more reliable solid-state battery package.

The dry-plating layer is a film obtained by a vapor phase method such as physical vapor deposition (PVD) and/or chemical vapor deposition (CVD), and has a very small thickness on the nano-order or the micro-order. Such a thin dry plating film contributes to more compact packaging. The dry plating film may contain, for example, at least one metal component/metalloid component selected from the group consisting of aluminum (Al), nickel (Ni), palladium (Pd), silver (Ag), tin (Sn), gold (Au), copper (Cu), titanium (Ti), platinum (Pt), silicon (Si), SUS, and the like, an inorganic oxide, a glass component, and/or the like. Preferably, the dry-plating layer contains SUS and/or Cu, and the covering inorganic layer containing such a material easily contributes to more suitable water vapor transmission prevention property of the solid-state battery package. For example, the thickness of the dry-plating layer 170a is preferably 1 μm to 10 μm, more preferably 2 μm to 8 μm, and still more preferably 3 μm to 6 μm. The dry-plating layer having a thickness within the above range can more easily and suitably contribute to prevention of water vapor from entering the solid-state battery 100.

The dry-plating layer 170a may be, for example, a sputtered film as described above. More particularly, the solid-state battery package according to the present disclosure may be provided with a sputtering thin film as a dry-plating film. The sputtered film is a thin film obtained by sputtering. More particularly, a film obtained by sputtering ions onto a target to eject and deposit the atoms thereof can be used as the dry-plating layer. The sputtered film easily becomes a relatively dense and/or homogeneous layer while having a significantly thin form on the nano-order or the micro-order, and thus easily contributes to preventing water vapor transmission to the solid-state battery. In addition, the sputtered film is formed by atomic deposition, and can be thus more suitably attached onto the target. Thus, the sputtered film is easily more suitably provided as a barrier for preventing water vapor in the external environment from entering the solid-state battery. Thus, the covering inorganic film further includes the sputtered film as the dry-plating layer, thereby the water vapor transmission prevention properties to the solid-state battery is easily further improved. The dry-plating layer may be formed by another dry plating, such as a vacuum deposition method and/or an ion plating method.

The wet-plating layer 170b has a layer formation rate (film formation rate) higher than that of the dry-plating film. Therefore, when a thick film is provided as the covering inorganic film, the combination of the dry-plating film with the wet-plating film helps efficient formation of the covering inorganic layer. Such a wet-plating layer may be based on electroplating or electroless plating. That is, the wet-plating layer may be obtained by such electroplating treatment or electroless plating. In electroplating, a plating solution is used, and electric energy is applied to the two electrodes, the cathode and the anode, electrically connected via an external electrode to form a plating layer. On the other hand, electroless plating is a plating method performed without the help of an external power source. That is, in electroless plating, a plating solution is used, but chemical reaction energy is mainly used without the help of an external power source, and a plating layer is formed.

In the solid-state battery package of the present disclosure, the wet-plating layer 170b may correspond to the outermost layer of the covering inorganic layer. That is, the wet-plating layer 170b may form the outermost layer in the solid-state battery package so as to extend to the whole of the main surface and the side surface of the solid-state battery package. Specifically, in the solid-state battery package, the outer main surface and the side surface may be covered with the wet-plating layer 170b.

In either electroplating or electroless plating, the plating raw material is liquid, and a liquid plating raw material containing water can be used. In plating, the plating solution erodes the plated object to sometimes cause defects in the plating layer formed more outside. The defects in the plating layer can deteriorate the function of the plating layer as a water vapor barrier. In the present disclosure, since the covering inorganic layer can be formed as a plating layer on the covering insulating layer having a smoothed surface, defects are easily suppressed in the covering inorganic layer, and such defects can be preferably eliminated. Therefore, the covering inorganic layer is more suitably provided as a water vapor barrier. From another viewpoint, when the adhesion of the covering inorganic layer provided as a plating layer on the covering insulating layer is improved or enhanced in the solid-state battery package, the covering inorganic layer more easily maintains (for example, easily maintains for a long period) the function as a water vapor barrier.

The smoothed layer and the covering inorganic layer may extend not only to the region on the substrate but also to the side surface of the substrate. Specifically, as illustrated in FIG. 5, the covering inorganic layer 170 and/or the smoothed layer 160B may extend to the side surface 250 of the substrate 200. In such a case, the bonding area between the covering inorganic layer and the substrate (for example, the bonding area between the covering inorganic layer and the substrate with the smoothed layer 160B interposed therebetween) is provided or increased, and peeling of the covering inorganic layer is further suppressed.

The thickness of each layer of the solid-state battery and the substrate may be based on an electron microscopic image. For example, the thickness of each layer constituting the solid-state battery and the substrate may be based on an image obtained by using an ion milling apparatus (model number SU-8040; manufactured by Hitachi High-Tech Corporation). That is, the thickness as used herein may refer to a value calculated from a dimension measured from an image obtained by such a method.

Similarly, the thickness of each layer of the covering portion such as the covering insulating layer and the covering inorganic layer may be based on an electron microscope image, and particularly may be based on a section electron microscope image. For example, the thickness may be based on an image obtained by using an ion milling apparatus (model number SU-8040; manufactured by Hitachi High-Tech Corporation) for the section obtained by cutting the solid-state battery package perpendicularly to the main surface. That is, the thickness of the covering material as used herein may refer to a value calculated from a dimension measured from an image obtained by such a method.

### [Method for Manufacturing Solid-State Battery Package]

The object of the present disclosure can be obtained through a process of preparing a solid-state battery that includes a battery constituent unit including a positive electrode layer, a negative electrode layer, and a solid electrolyte between the electrodes, and next packaging the solid-state battery.

The manufacture of the solid-state battery according to the present disclosure can be roughly divided into: manufacturing a solid-state battery itself corresponding to one before packaging (hereinafter, also referred to as an “unpackaged battery”); preparing a substrate; and packaging.

### <<Method for Manufacturing Unpackaged Battery>>

The unpackaged battery can be manufactured by a printing method such as screen printing, a green sheet method using a green sheet, or a combined method thereof. More particularly, the unpackaged battery itself may be fabricated in accordance with a conventional method for manufacturing a solid-state battery (thus, for raw materials such as the solid electrolyte, organic binder, solvent, optional additives, positive electrode active material, and negative electrode active material described below, those for use in the manufacture of known solid-state batteries may be used).

Hereinafter, for better understanding of the present disclosure, one manufacturing method will be exemplified and described, but the present disclosure is not limited to this method. In addition, the following time-dependent matters such as the order of descriptions are merely considered for convenience of explanation, and the present disclosure is not necessarily bound by the matters.

### (Formation of Stack Block)

The solid electrolyte, the organic binder, the solvent, and optional additives are mixed to prepare a slurry. Then, from the prepared slurry, sheets including the solid electrolyte are formed by firing.

The positive electrode active material, the solid electrolyte, the conductive material, the organic binder, the solvent, and optional additives are mixed to prepare a positive electrode paste. Similarly, the negative electrode active material, the solid electrolyte, the conductive material, the organic binder, the solvent, and optional additives are mixed to prepare a negative electrode paste.

The positive electrode paste is applied by printing onto the sheet, and a current collecting layer and/or a negative layer are applied by printing, if necessary. Similarly, the negative electrode paste is applied by printing onto the sheet, and a current collecting layer and/or a negative layer are applied by printing, if necessary.

The sheet with the positive electrode paste applied by printing and the sheet with the negative electrode paste applied by printing are alternately stacked to obtain a stacked body. Further, the outermost layer (the uppermost layer and/or the lowermost layer) of the stacked body may be an electrolyte layer, an insulating layer, or an electrode layer.

### (Formation of Battery Fired Body)

The stacked body is integrated by pressure bonding, and then cut into a predetermined size. The cut stacked body obtained is subjected to degreasing and firing. Thus, a fired stacked body is obtained. The stacked body may be subjected to degreasing and firing before cutting, and then cut.

### (Formation of End-Face Electrode)

The end-face electrode on the positive electrode side can be formed by applying a conductive paste to the positive electrode-exposed side surface of the fired stacked body. Similarly, the end-face electrode on the negative electrode side can be formed by applying a conductive paste to the negative electrode-exposed side surface of the fired stacked body. The end-face electrodes on the positive electrode side and the negative electrode side may be provided so as to extend to the main surface of the fired stacked body. The component for the end-face electrode can be selected from at least one selected from silver, gold, platinum, aluminum, copper, tin, and nickel.

Further, the end-face electrodes on the positive electrode side and the negative electrode side are not limited to being formed after firing the stacked body, and may be formed before the firing and subjected to simultaneous firing.

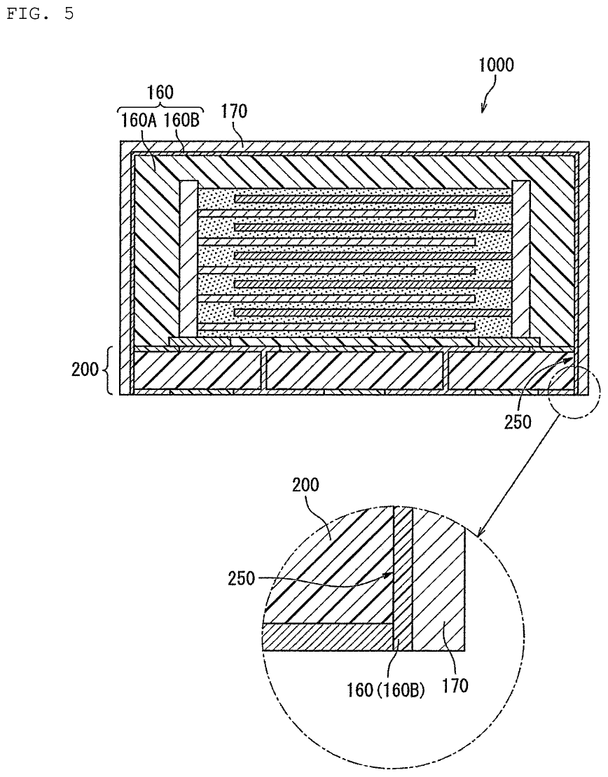

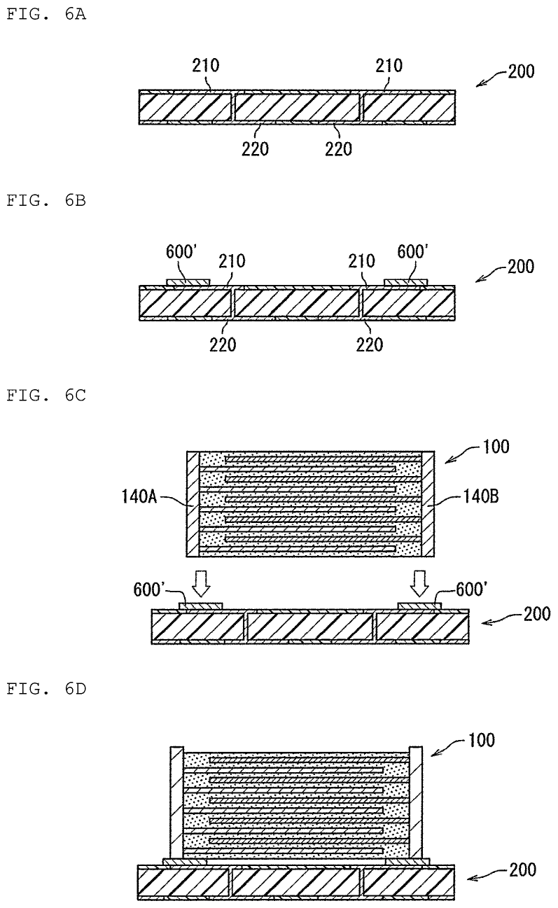

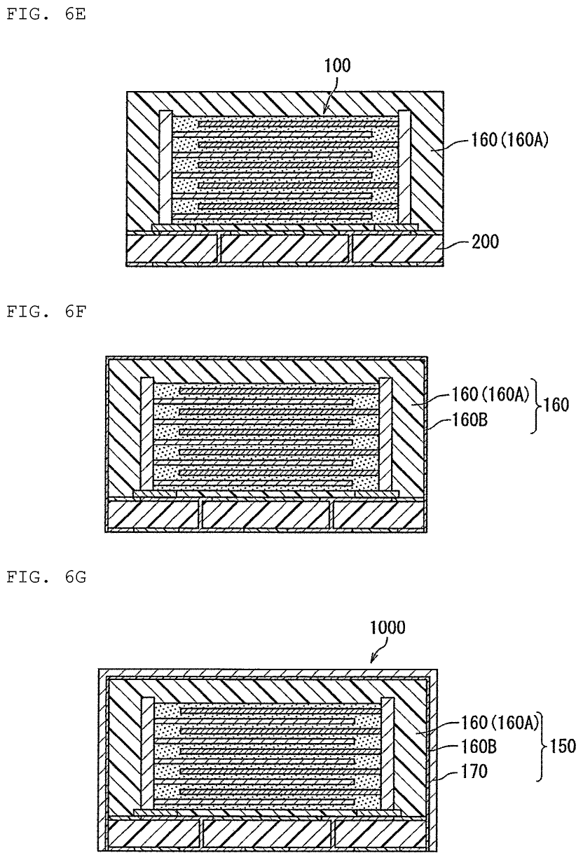

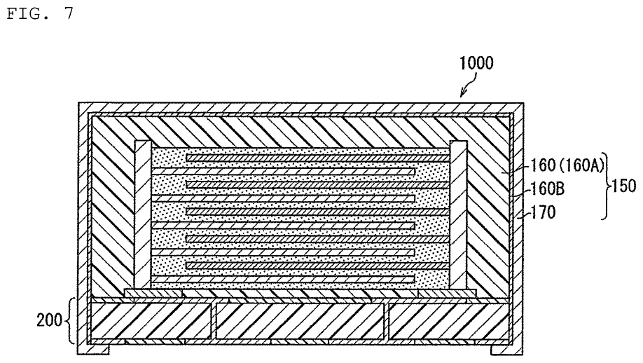

Through the steps described above, a desired unpackaged battery (corresponding to the solid-state battery 100 illustrated in FIG. 6C) can be finally obtained.

### <<Preparation of Substrate>>

In this step, the substrate is prepared.

Although not particularly limited, when a resin substrate is used as the substrate, the substrate may be prepared by stacking a plurality of layers and performing heating and/or pressure treatment. For example, a substrate precursor is formed using a resin sheet made by impregnating a fiber cloth as the substrate with a resin raw material. After the formation of the substrate precursor, the substrate precursor is subjected to heating and pressurization with a press machine. In contrast, when a ceramic substrate is used as the substrate, for the preparation thereof, for example, a plurality of green sheets can be subjected to thermal compression bonding to form a green sheet laminate, and the green sheet laminate can be subjected to firing, thereby providing a ceramic substrate. The ceramic substrate can be prepared, for example, in accordance with the preparation of an LTCC substrate. The ceramic substrate may have vias and/or lands. In such a case, for example, holes may be formed in the green sheet with a punch press, a carbon dioxide gas laser, and/or the like, and the holes may be filled with a conductive paste material, or a conductive part precursor such as vias or lands may be formed through a printing method or the like. Further, lands and the like can also be formed after firing the green sheet laminate.

Through the steps as described above, a desired substrate (corresponding to the substrate 200 illustrated in FIG. 6A) can be finally obtained.

### <<Packaging>>

Next, packaging is performed using the battery and the substrate obtained as mentioned above (see FIGS. 6A to 6G).

First, a bonding member precursor 600′ is formed on the substrate 200 (see FIGS. 6A and 6B), and an unpackaged battery 100 is disposed on the substrate 200 (see FIGS. 6C and 6D). More particularly, the “unpackaged solid-state battery” is disposed on the substrate (hereinafter, the battery used for packaging is also simply referred to as a “solid-state battery”).

Preferably, the solid-state battery is disposed on the substrate so as to electrically connect the conductive parts of the substrate and the end-face electrodes of the solid-state battery to each other. For example, a conductive paste may be provided on the substrate to form the bonding member precursor 600′, and the conductive parts of the substrate and the end-face electrodes of the solid-state battery may be electrically connected to each other through the precursor. More specifically, alignment is performed such that the conductive parts (in particular, lower land/bottom land) on the positive electrode side and the negative electrode side of the main surface of the substrate are respectively matched with the end-face electrodes as the positive electrode and the negative electrode of the solid-state battery, and the parts and the electrodes are bonded and connected using a conductive paste (for example, Ag conductive paste). More particularly, a bonding member precursor that is responsible for electrical connection between the solid-state battery and the substrate may be provided in advance. Such a bonding member precursor can be provided by printing a conductive paste that requires no flux cleaning or the like after the formation, such as a nano-paste, an alloy-based paste, and/or a brazing material, in addition to the Ag conductive paste. Subsequently, the solid-state battery is disposed on the substrate such that the end-face electrodes of the solid-state battery and the bonding member precursors are brought into contact with each other, and subjected to a heating treatment, thereby a bonding member that contributes to electrical connection between the solid-state battery and the substrate is formed from the precursor.

Next, the covering portion is formed. The covering insulating layer 160 having a smoothed surface is provided as a component of the covering portion (see FIG. 6E). Here, the covering insulating layer having a smoothed surface can be obtained by controlling the content of the filler such that the filler is charged in the raw material in a lower amount or the filler is not contained (That is, the covering insulating layer can be provided as a covering insulating layer having a low filler content or a covering insulating layer containing no filler). When the smoothed layer is provided on the covering insulating layer, the first covering insulating layer is formed, and then the smoothed layer is formed thereon as the second insulating layer. Thus, such a covering insulating layer having a smoothed surface can be obtained.

In forming the covering portion, first, the covering insulating layer 160 is formed to cover the solid-state battery 100 on the substrate 200 (see FIG. 6E). For example, the covering insulating layer (first covering insulating layer) that is in direct contact with the solid-state battery 100 or directly covers the solid-state battery 100 is formed. For such formation, for example, a raw material of the covering insulating layer is provided so that the solid-state battery on the substrate is covered as a whole. When the covering insulating layer is made of a resin material, a resin precursor is provided on the substrate and subjected to curing or the like to mold the covering insulating layer. According to a preferred embodiment, the covering insulating layer may be molded by pressurization with a mold. By way of example only, a covering insulating layer for sealing the solid-state battery on the substrate may be molded through compression molding. As long as a resin material generally used in molding, the form of the raw material for the covering insulating layer may be granular, and the type thereof may be thermoplastic. Such molding is not limited to die molding, and may be performed through polishing processing, laser processing, and/or chemical treatment.

When the smoothed layer 160B is used for the covering insulating layer 160 having a smoothed surface, the smoothed layer 160B may be formed after a covering insulating layer corresponding to the first covering insulating layer 160A is molded by the above method. Specifically, for example, an alkoxysilane solution is prepared as a raw material solution for the smoothed layer, and the solution is used to form the smoothed layer 160B as the surface layer of the covering insulating layer 160 (For example, the smoothed layer 160B may be formed by impregnation treatment using the solution).

After the smoothed layer 160B is formed, the covering inorganic layer 170 is formed. When the covering insulating layer 160 achieves a desired smoothed surface without the smoothed layer 160B, the covering insulating layer 160 not having such a smoothed layer is formed, and then the covering inorganic layer 170 is formed. In other words, the covering inorganic layer 170 is formed on the “covering precursor in which each solid-state battery 100 on the substrate 200 is covered with the covering insulating layer 160 having a smoothed surface configuration”.

The covering inorganic layer may be formed by plating the covering precursor. In an embodiment, the plating layer may be formed on the exposed surfaces of the covering precursor other than the bottom surface (that is, other than the bottom surface of the support substrate), thereby forming the covering inorganic layer on the covering precursor.

When the covering inorganic layer is provided as a plating layer, a plurality of plating layers may be laminated by performing dry-plating and wet-plating in a predetermined order. For example, in an embodiment of the present disclosure, the covering precursor may be subjected to single layer dry-plating, and then a plurality of types of wet-plating may be sequentially performed. The dry-plating layer, the first wet-plating layer, and the second wet-plating layer may be laminated in this order.

The wet-plating can be performed by, for example, electroplating or electroless plating. When emphasis is placed on the film-forming rate of the plating, the wet-plating layers are more preferably formed by electroplating. Thus, in an embodiment of the present disclosure, the wet-plating layer can be formed by electroplating, and thus, the wet-plating layer can also be referred to as an electroplating layer.

As the metal source of the plating solution used for wet-plating, various forms may be used depending on the type of the dry-plating layer and/or the plating bath, and the like. The metal source is not particularly limited, but for example, a metal salt of a metal contained in the plating composition, for example, an inorganic acid salt such as a sulfate, a hydrochloride, a pyrophosphate, and/or a sulfamic acid, and/or an organic acid salt such as a cyanide salt can be used. In addition, if necessary, various supporting electrolytes and additives (stress-reducing agent, brightener, conductive auxiliary agent, reducing agent, defoaming agent, dispersant, surfactant, and/or the like) can be contained in the plating solution. Examples of plating conditions include current density, temperature, pH, and/or the like, and these conditions can be arbitrarily set. When electroplating is used to form a plating layer, the plating means may be direct-current plating or pulse plating.

Through the steps described above, it is possible to obtain a packaged article in which the solid-state battery on the substrate is totally covered with the “covering insulating layer having a smoothed surface” and the covering inorganic film. More particularly, the “solid-state battery package” according to the present disclosure can be finally obtained.

In the above description, a form in which the covering portion 150 covers the solid-state battery 100 has been mentioned, but the present disclosure may have a form in which the solid-state battery 100 is largely covered with the covering portion 150. For example, the covering inorganic layer 170 provided on the covering insulating layer 160 that covers the solid-state battery 100 on the substrate 200 may extend to the lower main surface of the substrate 200 (see FIG. 7). That is, as the covering portion 150, the covering inorganic layer 170 on the covering insulating layer 160 may extend to the side surface of the substrate 200, and may extend to the lower main surface (for example, particularly, the peripheral edge portion thereof) of the substrate 200 beyond the side of the substrate 200. In such a form, a solid-state battery package can be provided in which moisture transmission (moisture transmission from the outside to the solid-state battery stacked body) is more suitably prevented. Although not illustrated, a metal pad may be provided between the lower main surface of the substrate and the covering inorganic layer in order to further strengthen the bonding between the covering inorganic layer and the substrate. Such a metal pad may be provided, for example, on the peripheral edge of the lower main surface of the substrate.

A water vapor barrier layer may be separately provided to obtain a solid-state battery package. For example, a separate water vapor barrier layer may be provided to the substrate to be packaged (as one example, on the main surface of the substrate). More particularly, a water vapor barrier may be formed to the substrate before packaging, where the substrate and the solid-state battery are combined. The water vapor barrier layer is not particularly limited as long as a desired barrier layer can be formed. For example, “a water vapor barrier layer having Si—O bonds and Si—N bonds” is preferably formed through application of a liquid raw material and ultraviolet irradiation. More particularly, the water vapor barrier layer may be formed under a relatively low temperature condition (for example, a temperature condition on the order of 100° C.) without using any vapor-phase deposition method such as CVD and/or PVD.

Specifically, a raw material containing, for example, silazane is prepared as a liquid raw material, and the liquid raw material is applied to the substrate by spin coating, spray coating, or the like, and dried to form a barrier precursor. Then, the barrier precursor can be subjected to UV irradiation in an environmental atmosphere containing nitrogen, thereby providing the “water vapor barrier layer having Si—O bonds and Si—N bonds”.

In order that the water vapor barrier layer is not present at the bonding site between the conductive parts of the substrate and the end-face electrodes of the solid-state battery, it is preferable to locally remove the barrier layer at the site. Alternatively, a mask may be used so that the water vapor barrier layer is not formed at the bonding site. More particularly, the water vapor barrier layer may be totally formed with a mask applied to the region for the bonding site, and then the mask may be removed.

Although the embodiments of the present disclosure have been described above, only typical examples have been illustrated. Those skilled in the art will easily understand that the present disclosure is not limited thereto, and various embodiments are conceivable without changing the scope of the present disclosure.

For example, in the above description, a wet-plating layer having a two-layer structure (the first wet-plating layer and the second wet-plating layer) as the covering inorganic layer has been mentioned, but the present disclosure is not necessarily limited thereto. The wet-plating layer may have a configuration of more than two layers. For example, in the wet-plating layer, a third wet-plating layer may be provided in addition to the first wet-plating layer and the second wet-plating layer.

Although the resin layer containing a resin has been mentioned as the smoothed layer, such a resin layer may contain silicon oxide. For example, silicon oxide may be contained in the smoothed layer containing Si (silicon) as the constituent element of the layer resin material (for example, a smoothed layer as a resin material containing an alkoxysilane) or in the smoothed layer containing no Si (silicon) as the constituent element of such a layer resin material. That is, the smoothed layer (for example, a smoothed layer as a silicon-containing resin layer or a smoothed layer as a resin layer containing no silicon) may contain silicon oxide (for example, silicon oxide fillers). In such a case, the smoothed layer may be provided on the surface of the covering insulating layer by applying a raw material containing silicon oxide to the covering insulating layer. The kind of silicon oxide contained in the smoothed layer is not particularly limited (for example, silicon dioxide).

It is to be confirmed that the present disclosure can also be applied to the following embodiment in terms of another aspect.

A solid-state battery package including: a substrate; a solid-state battery on the substrate; and a covering portion including at least: a covering insulating layer covering the solid-state battery; and a covering inorganic layer outside the covering insulating layer, wherein a smoothed layer is provided between the covering inorganic layer and the covering insulating layer, and the smoothed layer contains silicon.

### Examples

A demonstration test was conducted according to the present disclosure. The structure of FIG. 2 was employed for the structure of the solid-state battery package.

Specifically, solid-state battery packages having a covering insulating layer and a covering inorganic layer of each of Comparative Examples 1 and 2 and Examples 1 to 4 shown in Table 1 below were produced.

TABLE 1

| | | | | | Smoothness of |
|---|---|---|---|---|---|
| | | | | | covering |
| | | | | | insulating |
| | Covering insulating layer | | | | layer |
| | First covering | | | | Developed |
| | insulating layer | | Second covering insulating | | area ratio |
| | | Silicon | layer (Insulating layer on | | Sdr of |
| | | oxide | first covering insulating | | interface |
| | | filler | layer (smoothed layer)) | | with covering |
| | | content | | Thickness | inorganic |
| | Resin | (wt %) | Presence/Absence | (μm) | layer |
| Comparative | Thermosetting | 30 | Absent | — | 0.257 |
| Example 1 | resin | | | | |
| Comparative | Thermosetting | 10 | Absent | — | 0.166 |
| Example 2 | resin | | | | |
| Example 1 | Thermosetting | 5 | Absent | — | 0.137 |
| | resin | | | | |
| Example 2 | Thermosetting | 0 | Absent | — | 0.101 |
| | resin | | | | |
| Example 3 | Thermosetting | 30 | Present (silicon- | 1.23 | 0.082 |
| | resin | | containing layer) | | |
| Example 4 | Thermosetting | 30 | Present (silicon- | 1.97 | 0.044 |
| | resin | | containing layer) | | |

| | | | Adhesion | Defects | Water vapor | |
|---|---|---|---|---|---|---|
| | Covering | | of | in | transmission | Water vapor |
| | inorganic layer | | covering | covering | rate | transmission- |
| | Dry- | Wet- | inorganic | inorganic | @85° C.85% RH | preventing |
| | plating | plating | layer | layer | (g/m2 · day) | property |
| Comparative | SUS/Cu | Cu/Ni | Class A | X | 2.66 | X |
| Example 1 | | | | Defect | | |
| Comparative | SUS/Cu | Cu/Ni | Class A | X | 1.38 | X |
| Example 2 | | | | Defect | | |
| Example 1 | SUS/Cu | Cu/Ni | Class B | ◯ | 0.18 | ◯ |
| | | | | No defect | | |
| Example 2 | SUS/Cu | Cu/Ni | Class C | ◯ | 0.19 | ◯ |
| | | | | No defect | | |
| Example 3 | SUS/Cu | Cu/Ni | Class A | ◯ | 0.08 | ◯ |
| | | | | No defect | | |
| Example 4 | SUS/Cu | Cu/Ni | Class A | ◯ | 0.07 | ◯ |
| | | | | No defect | | |

As the thermosetting resin of the insulating resin layer in Comparative Examples 1 to 2 and Examples 1 to 4, an epoxy resin was used.

As the filler in Comparative Examples 1 to 2 and Examples 1 and 3 to 4, a SiO₂ filler was used (The wt % is based on the first covering insulating layer). In other words, silicon dioxide was used as the silicon and silicon oxide contained in the insulating resin layer.

As the silicon-containing layer in Examples 3 and 4, a layer containing an alkoxysilane was used. More specifically, an alkoxysilane solution was provided on the surface of the first covering insulating layer of the covering insulating layer to form a silicon-containing layer as the second covering insulating layer (smoothed layer).

For the thickness (thickness in Table 1) in Examples 3 and 4, a smoothed layer was applied on a glass plate under the same conditions as those produced above, and the film thickness was measured using a reflectance spectrophotometer (model number F20-EXR; manufactured by FILMETRICS). Five samples were measured, and the average value thereof was adopted.

The smoothness of the covering insulating layer was evaluated by measuring the developed area ratio Sdr of the covering insulating layer. For the evaluation of Sdr, the surface roughness was measured to calculate Sdr, using a laser microscope (model number VK-X3050, which is manufactured by KEYENCE CORPORATION). Twenty samples were measured, and the average value thereof was adopted.

For defects in the covering inorganic layer, a microscope (model number VHX-6000, which is manufactured by KEYENCE CORPORATION) was used. Five samples were observed at a magnification of 300 times. A covering inorganic layer having a hole was regarded as “Defect”.

The adhesion of the covering inorganic layer was evaluated by a method in accordance with JIS K5600-5-6 “Testing methods for paints: Mechanical property of film: Adhesion test (Cross-cut test)”. A cross-cut test was performed in a state after dry-plating was performed, and grading was performed according to the results. The evaluation results for five samples each are shown in Table 1.

Class A: The edge of the cut is totally smooth, and there is no peeling in any lattice.

Class B: The coating film has a small peeling at the intersection of the cuts, but not more than 5% of the cross-cut part is adversely affected.

Class C: The coating film is partly peeled off along the edge of the cut, but more than 15% and not more than 35% of the cross-cut part is adversely affected.

The water vapor transmission rate was calculated by: 20 solid-state battery packages produced were left standing under an environment of 85° C. and 85% RH for 24 hours; and then the weight change amount was divided by the surface area of the product. The average value of the 20 samples is shown in Table 1. For weight measurement, used was an ultramicrobalance (model number XP2UV; manufactured by METTLER TOLEDO).

As can be seen from the results shown in Table 1, the covering insulating layer has insufficient smoothness in Comparative Examples 1 to 2. That is, as shown in Comparative Examples 1 to 2, defects in the covering inorganic layer were observed when the interface between the covering insulating layer and the covering inorganic layer had a developed area ratio Sdr of more than 0.15. Therefore, in the comparative example in which defects were observed, the water vapor transmission rate was also higher than that in Examples (More specifically, in Comparative Examples 1 to 2, the water vapor transmission rate value was 1.0 g/(m²·day) or more, which was higher than that in Examples). On the other hand, in Examples 1 to 4, the covering insulating layer had a desired smoothed surface, specifically, the covering insulating layer had a developed area ratio Sdr of 0.15 or less, thereby a more preferable solid-state battery package was successfully obtained, having no defects in the covering inorganic layer and exhibiting a desired lower water vapor transmission rate (More specifically, Examples 1 to 4 exhibited more preferable water vapor transmission properties: the water vapor transmission rate value was less than 1.0 g/(m²·day), specifically less than 0.5 g/(m²·day), and more specifically less than 0.2 g/(m²·day)). Therefore, according to the present disclosure, it has been found that a solid-state battery package capable of further improving the water vapor transmission prevention property can be obtained.

Note that Table 1 also indicates the following.

The smoothness of the covering insulating layer can be controlled by the filler content in the covering insulating layer. That is, by such control, the covering insulating layer can have a developed area ratio Sdr of 0.15 or less, thereby the covering insulating layer can have a suitably smoothed surface.

When the covering insulating layer will have increased surface irregularities (for example, when the content of the filler in the covering insulating layer increases), the covering insulating layer can have a developed area ratio Sdr of 0.15 or less (more preferably less than 0.1) by providing the smoothed layer, thereby the covering insulating layer can have a suitably smoothed surface.

The “silicon” in the silicon and silicon oxide contained in the covering insulating layer and/or in the silicon-containing layer provided as the smoothed layer and the like may contribute significantly in terms of more suitable adhesion of the covering inorganic layer to the covering insulating layer.

The solid-state battery package according to the present disclosure can be used in various fields where battery use or power storage can be assumed. By way of example only, the solid-state battery package according to the present disclosure can be used in the fields of electricity, information, and communication in which mobile devices and the like are used (such as the field of electric/electronic devices and the field of mobile devices including small electronic devices such as mobile phones, smartphones, notebook computers and digital cameras, activity trackers, arm computers, electronic paper, RFID tags, card-type electronic money, and smartwatches), home and small industrial applications (such as the fields of power tools, golf carts, and home, nursing, and industrial robots), large industrial applications (such as the fields of forklifts, elevators, and harbor cranes), the field of transportation systems (such as the fields of hybrid vehicles, electric vehicles, buses, trains, power-assisted bicycles, and electric two-wheeled vehicles), power system applications (such as the fields of various types of power generation, road conditioners, smart grids, and home energy storage systems), medical applications (field of medical equipment such as earphone hearing aids), pharmaceutical applications (fields such as dosage management systems), IoT fields, space and deep sea applications (such as the fields of space probes and submersibles), and the like.

### DESCRIPTION OF REFERENCE SYMBOLS

100: Solid-state battery
100A: Main surface of solid-state battery (In particular, upper surface, that is, main surface located relatively on distal side with respect to substrate)
100B: Side surface of solid-state battery
100C: Main surface of solid-state battery (In particular, lower surface, that is, main surface located relatively on proximal side with respect to substrate)
110: Positive electrode layer
120: Negative electrode layer
130: Solid electrolyte or solid electrolyte layer
140: End-face electrode
140A: Positive-electrode-side end-face electrode
140B: Negative-electrode-side end-face electrode
150: Covering portion/Covering material
160: Covering insulating layer
160′: Smoothed surface of covering insulating layer
160A: Covering insulating layer that is positioned relatively inside second insulating layer (relatively inner side layer)/first covering insulating layer)
160B: Smoothed layer (covering insulating layer that is positioned relatively outside first insulating layer (relatively outer side layer)/second covering insulating layer)
170: Covering inorganic layer
170a: Dry-plating layer
170b: Wet-plating layer
200: Substrate
210: Substrate electrode layer (upper side of substrate)
210A: Positive-electrode-side substrate electrode layer
210B: Negative-electrode-side substrate electrode layer
220: Substrate electrode layer on mounting side (lower side of substrate)
220A: Positive-electrode-side substrate electrode layer on mounting side
220B: Negative-electrode-side substrate electrode layer on mounting side
250: Side surface of substrate
600: Bonding member
600′: Bonding member precursor
1000: Solid-state battery package

1. A solid-state battery package comprising:
a substrate;
a solid-state battery on the substrate; and
a covering portion including at least:
a covering insulating layer covering the solid-state battery; and
a covering inorganic layer outside the covering insulating layer,
wherein the covering insulating layer has a smoothed surface.

2. The solid-state battery package according to claim 1, wherein the covering insulating layer has a developed area ratio Sdr of 0.15 or less.

3. The solid-state battery package according to claim 1, wherein the smoothed surface is a surface at an interface between the covering insulating layer and the covering inorganic layer.

4. The solid-state battery package according to claim 3, wherein the smoothed surface has a developed area ratio Sdr of 0.15 or less.

5. The solid-state battery package according to claim 1, wherein the covering insulating layer includes a smoothed layer, and the covering inorganic layer is on the smoothed layer.

6. The solid-state battery package according to claim 5, wherein the smoothed layer has a developed area ratio Sdr of 0.15 or less.

7. The solid-state battery package according to claim 5, wherein the smoothed layer surrounds the solid-state battery.

8. The solid-state battery package according to claim 1, wherein the covering inorganic layer is a plating layer.

9. The solid-state battery package according to claim 8, wherein the plating layer has a dry-plating layer on the covering insulating layer and a wet-plating layer on the dry-plating layer.

10. The solid-state battery package according to claim 1, wherein the covering insulating layer contains silicon.

11. The solid-state battery package according to claim 1, wherein the covering insulating layer contains silicon oxide.

12. The solid-state battery package according to claim 5, wherein the smoothed layer is a silicon-containing layer that contains silicon.

13. The solid-state battery package according to claim 12, wherein the silicon-containing layer has a developed area ratio Sdr of 0.15 or less.

14. The solid-state battery package according to claim 12, wherein the silicon-containing layer contains an alkoxysilane.

15. The solid-state battery package according to claim 1, wherein the covering inorganic layer contains at least one metal selected from Cu, Sn, Zn, Bi, Au, Ag, Ni, Cr, Pd, Pt, SUS, and Zn.

16. The solid-state battery package according to claim 9, wherein the wet-plating layer includes at least a first wet-plating layer and a second wet-plating layer, and the first wet-plating layer contains at least one metal selected from Cu, Sn, Zn, Bi, Au, and Ag.

17. The solid-state battery package according to claim 16, wherein the second wet-plating layer contains at least one metal selected from Ni, Cr, Pd, Pt, Zn, and Cu.

18. The solid-state battery package according to claim 9, wherein the dry-plating layer contains SUS and/or Cu.

19. The solid-state battery package according to claim 5, wherein the smoothed layer has a thickness of 1 μm or more.
